(19) United States
(12) Patent Application Publication
(10) Pub. No.: US 2007/0276746 A1
(43) Pub. Date: Nov. 29, 2007

(54) Real estate management system for use by managers and agents

(76) Inventor: David Michonski, Greenwich, CT (US)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(21) Appl. No.: 11/027,530

(22) Filed: Dec. 30, 2004

(51) Int. Cl. G06Q 40/00

(52) U.S. Cl. 705/37

(57) ABSTRACT

In accordance with the invention, a method of implementing and controlling a real estate transaction includes the receiving of an agent identification from a particular agent and a request from the agent to implement the real estate transaction with respect to a particular property. These transactions are presented on a screen, or a plurality of screens, to the agent which shows a listing of a plurality of tasks to be done in connection with the real estate transaction, a plurality of fields for receiving information and a plurality of icons linking to request forms to be filled out and generating a requested item cost associated with a task, if any, and storing cost(s) as cost information associated with a property and/or agent. Further in accordance with the present invention, the transaction includes receiving of information in respect to the type of the property and the value of the property, generating average cost figures associated with properties of different types and values and costs incurred by the particular agent. In addition, a report is generated which indicates the cost associated with the particular property or particular agent compared to the average cost figures. The inventive method contemplates that the plurality of fields receives information indicating the details of a particular property associated with the real estate transaction. In accordance with the particularly preferred embodiment of the invention, filled-in request forms are stored. Stored forms are forwarded to a manager for approval or amendment. An approval or amendment is received from the manager. The system then forwards the filled-in request form and any amendment to a supplier in response to the receipt of the approval or amendment. This task may be forwarded and implemented over the Internet.

### TECHNICAL FIELD

This invention relates to a method and apparatus for use by managers and agents in the efficient and quality-controlled implementation of a real estate transaction utilizing the Internet or an equivalent communications system.

### REFERENCE TO GOVERNMENT FUNDING

Not Applicable.

### BACKGROUND OF THE INVENTION

During the recent rise of the Internet, a myriad of applications have been introduced to change and/or replace the infrastructure and methodology of the real estate business. Implementations range from the total transaction of business over the Internet, to real estate company websites which showcase properties available for sale and which are meant as an adjunct (similar to newspaper advertising) to traditional person-to-person real estate agent/buyer interactions.

See for example United States Patent No. US 2004/0143450 A1 which includes the provision of customized websites for participants in a real estate transaction, including agents, buyers, sellers and service providers. In accordance with the system proposed by Vidali, services required for closing, such as inspection, title report or appraisal, may be ordered from the service providers.

Yet another approach is illustrated by U.S. Pat. No. 6,321,202 of Raveis, which proposes the management of real estate transactions for receiving and storing data from contacts including buyers and sellers of real estate, assessing vendor data and communicating data to vendors.

All of the above systems have major shortcomings which are addressed by the system and method of the present invention.

### SUMMARY OF THE INVENTION

In accordance with the invention, a method of implementing and controlling a real estate transaction includes the receiving of an agent identification from a particular agent and a request from the agent to implement the real estate transaction with respect to a particular property. These transactions are presented on a screen, or a plurality of screens, to the agent which shows a listing of a plurality of tasks to be done in connection with the real estate transaction, a plurality of fields for receiving information and a plurality of icons linking to request forms to be filled out and generating a requested item cost associated with a task, if any, and storing cost(s) as cost information associated with a property and/or agent.

Further in accordance with the present invention, the transaction includes receiving of information in respect to the type of the property and the value of the property, generating average cost figures associated with properties of different types and values and costs incurred by the particular agent. In addition, a report is generated which indicates the cost associated with the particular property or particular agent compared to the average cost figures.

The inventive method contemplates that the plurality of fields receives information indicating the details of a particular property associated with the real estate transaction. In accordance with the particularly preferred embodiment of the invention, filled-in request forms are stored. Stored forms are forwarded to a manager for approval or amendment. An approval or amendment is received from the manager. The system then forwards the filled-in request form and any amendment to a supplier in response to the receipt of the approval or amendment. This task may be forwarded and implemented over the Internet.

Further in accordance with the inventive method, deadline dates may be set for agents and managers in response to the receiving of the request. Agent task performance and manager approval performance information is received into a task and approval performance database. The task and approval performance database is, optionally, periodically checked and updated in response to management and agent actions to ascertain whether a deadline item has been executed, or an approval or amendment given. A reminder is sent to a manager for those unperformed tasks for which a manager is responsible with respect to an unexecuted item and/or to an agent for an unexecuted task for which the agent is responsible.

A public website is implemented and configured to incorporate the details. Personal details on an agent are included in the public website.

Further, the inventive method accommodates the placement of an advertisement in a store front window. An icon on said screen associated with a representation of the task may be clicked upon to implement a request for a replacement of an advertisement in front of a storefront window.

The inventive method also provides for receiving the agent information comprising an advertisement, a scheduling of an open house or an order for a photo shoot or virtual tour of a listed property.

In addition, the advertisement, scheduling of an open house, or photo shoot or virtual tour of the listed property may go to a manager for approval before it is transmitted.

Further in accordance with the invention, a screen or screens of the inventive method may present hyperlinks to a plurality of programs for agents.

The plurality of programs comprises an agent education program, wherein the agent can use online educational facilities and may take online courses related to a specific field of real estate. Other programs may also be implemented. An agent profile program provides for the agent to enter personal information detailing their experience in the real estate field, such as education level, prior work experience, and/or their performance level. An incentives program databases cumulative points earned by the agents. The number of cumulative points is a function of factors selected from the group consisting of, for example, agent performance, associated points, algorithmic assessments of the same, coworker and customer feedback, educational courses completed and manager ratings. A concierge program may be presented to the agent information respecting resources to help buyers and sellers of real estate to maintain and move into the particular property. A relocation program presents to the agent relocation information to further assist buyers and sellers.

### BRIEF DESCRIPTION OF THE DRAWINGS

The advantages and operation of the invention system and method will be understood from the following drawings, which only illustrate one embodiment of the invention, in which:

FIG. 1 is a schematic diagram of the database structure of the inventive system;

FIG. 2 is a block diagram of a portion of the inventive method;

FIG. 3 is an illustration of the homepage of a website implementing the inventive method;

FIG. 4 is an illustration of a Listings page accessible from the FIG. 3 homepage;

FIG. 5 is an illustration of a drop-down menu under the Manage Listing button of the Listings page;

FIG. 6 is an illustration showing an Agent Essentials page;

FIG. 7 is an illustration showing a Broker to Broker page;

FIG. 8 is an illustration showing a Customer Marketing page;

FIG. 9 is an illustration showing a Data Feedback page;

FIG. 10 is an illustration showing an Exit the Listing page;

FIG. 11 is an illustration showing a drop-down menu under the Manage Listings button on the homepage;

FIG. 12 is a block diagram of the inventive method features providing the home page options for a user at the homepage;

FIG. 13 is a block diagram of the back-office portion of the inventive system;

FIG. 14 is an illustration showing the back-office portion of submenu items under the Manage Listings button of FIG. 13.

### DETAILED DESCRIPTION OF THE PREFERRED EMBODIMENT

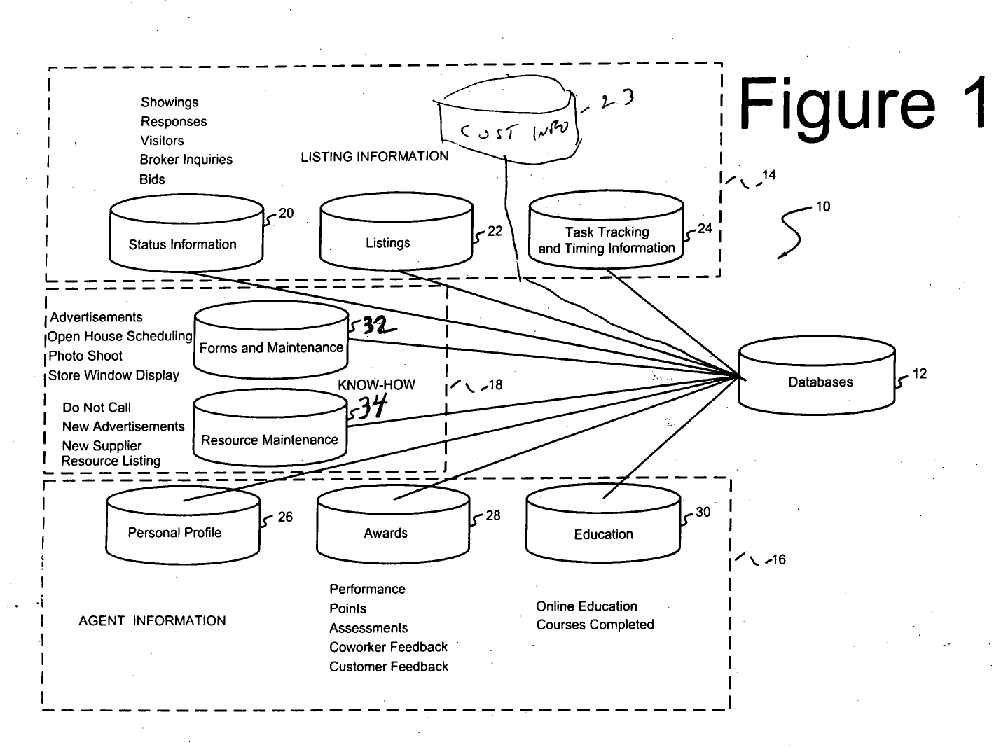

Referring to FIG. 1, the database structure 10 of the present invention may be understood. Generally, databases 12 comprise listing specific information 14, agent specific information 16 and know-how 18.

Listing information includes status information 20 respecting the status of each particular listing of a real estate property. Such information may include a record of bids made against a particular property, broker or customer inquiries respecting the same, a list of the visitors who have seen the property, a list of visitors to the web site page or pages devoted to the property (perhaps detailing review of pictures or virtual tours), a record of responses to advertising, and records of showings open houses, and the like.

Also included in the listing information is a database 22 which has basic information on the listings, such as the multiple listing service (MLS) number, address, the date of listing, and/or similar information. A database 23 is used to store cost information (e.g. for advertisements, photography, etc.).

The multiple listing service is operated in association with a database which enables brokers from various real estate agencies to access and sale properties associated with listings of other real estate agencies.

In accordance with the present invention, certain tasks associated with a listing, such as the writing and sending of postcards advertising the listing, brochures, or the like, the placement of advertising, the mailing of brochures, and other tasks, as more fully appears below, are tracked, and their performance is recorded in database 24 to allow for reminders and the avoidance of duplicate effort.

In accordance with the invention, information regarding agents must also be maintained. Such information is maintained as agent information 16 including a database of personal profiles 26 of the various agents working with a particular real estate agency. In accordance with the invention such information is accessible to the agents for updating.

Agents earn incentives by the granting of awards. Awards are well-known in the real estate industry. Information respecting agents' performance, associated points, algorithmic assessments of the same, coworker and customer feedback, educational courses completed, and supervisor ratings may be maintained in an awards database 28.

In a similar fashion, a database 30 containing educational information is maintained, including each particular agent's use of online educational facilities, and courses successfully completed. The educational database 30 may also contain actual courses for downloading by agents.

Know how database 18 includes a database 32 of forms for various tasks, including writing advertisements, scheduling open houses, ordering a photo shoot or virtual tour of a listed property and placing a property in a store window display. A resource database 34 provides information regarding suppliers, a list of persons who have asked not to be called, and the like.

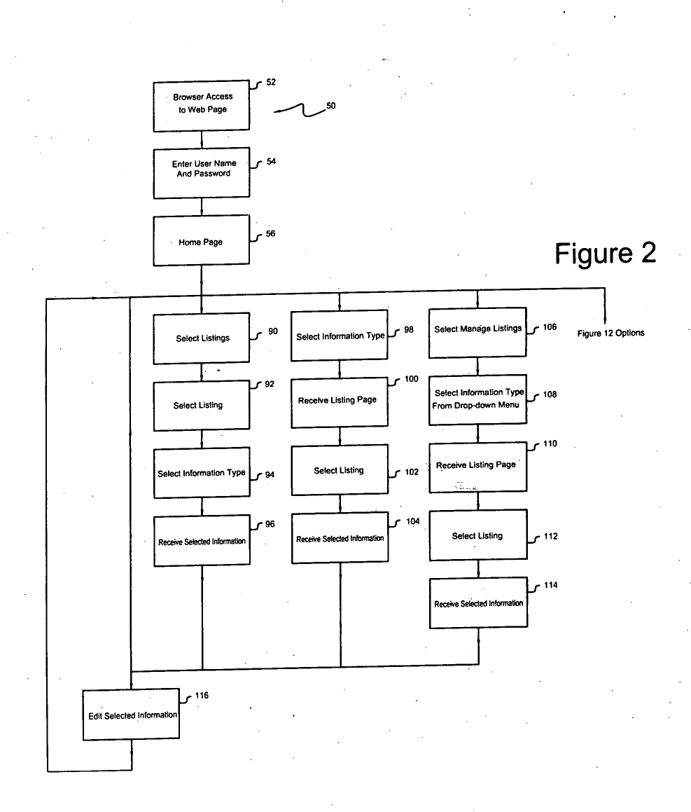

The inventive method 50 is illustrated in FIG. 2. In accordance with the invention, it is contemplated that the system will be used by agents working in the field in association with the real estate agency operating the inventive system in conjunction with an Internet web site. Agents access the system at step 52 by entering the Web address of the inventive system using a conventional browser on, for example, a home-type personal computer, of the type commonly available in retail outlets and manufactured by such companies as IBM, Dell, Compaq and others.

Sign-on, by entering a user name and password at step 54, is performed in a conventional manner.

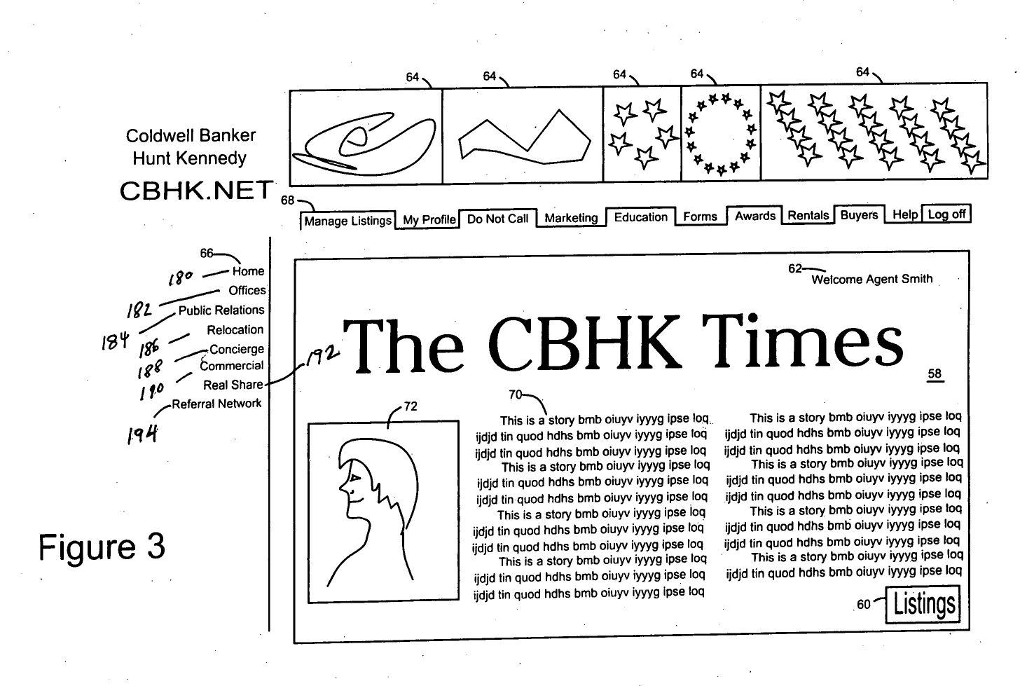

At step 56, the homepage associated with the web site implementing the inventive method is presented. The homepage takes the form illustrated, for example, in FIG. 3. It may include general information in the form of a newsletter 58 and a link 60 which may be clicked on to access listings. In accordance with the preferred embodiment such listings would be sales listings although, in principle, it may link to an intermediate page where the user will have the opportunity of selecting between listed rentals and listed properties for sale. A personalized welcome 62, naming the agent by name, may also be included in the system. The page may also include a number of photographs, for example of the neighborhood where the real estate agency operates or other subjects of relevant interest, such as photographs 64.

The system also includes a menu of a number of informational selections 66, together with a number of task specific selections 68, which may be made by the user, as is more fully described below.

Finally, the homepage includes one or more articles 70, which have the objective of addressing particular issues and/or correcting problems, building morale or the like for the organization operating the inventive web site. Such articles may include illustrations 72, such as an picture of a new real estate agent.

Selection of the Manage Listings will create a drop-down menu which presents, to agents associated with the agency, five items, namely, Agent Essentials, Broker to Broker Marketing, Customer Marketing, Data Feedback, and Exiting the Listing. Clicking on any of these items in the drop-down menu, will lead the user to a page titled My Listings in which the user can see information on those properties for which he is responsible. It is noted that this listing is not complete for the real estate agency. Rather, a complete listing can be accessed by the public or the agent by going to the publicly available web site, which requires no user name or ID to enter and search that website.

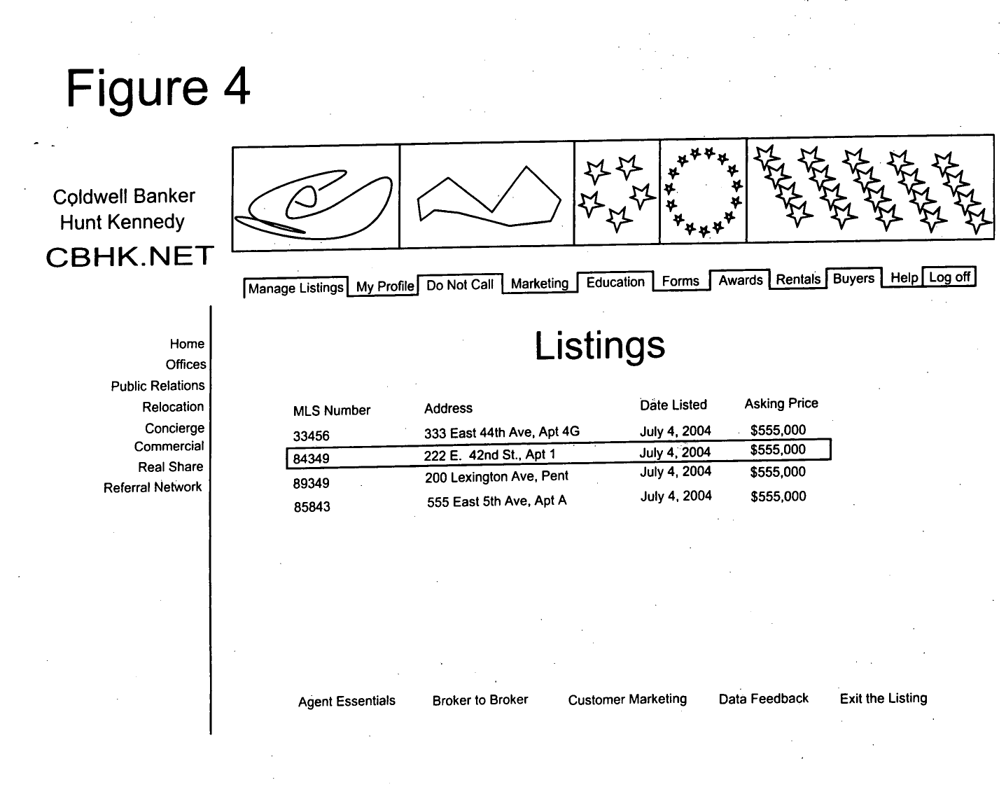

In accordance with the invention, the My Listings page may take the form illustrated in FIG. 4.

In connection with this, it is noted that the publicly available web site and the agency's internal web site illustrated in FIG. 3 have the same name with different extensions, for example cbhk.com for the publicly available web site and cbhk.net for the privately accessible internal website to be used by agents to manage their listings in accordance with the present invention.

Further in accordance with the present invention, it is contemplated that the publicly available page will have a series of listings pages, divided, for example, according to neighborhood, which would have the same information as the information in the listings page of FIG. 4, but also including a fifth column, including the name of the agent. This name would act as a hyperlink and when clicked on would generate an e-mail to the agent allowing a member of the public or another agent to communicate with the agent respecting to the specific property, the e-mail automatically listing the subject property in the “Re:” line of the e-mail.

In accordance with the present invention, clicking on the MLS Number in the publicly available web site will result in generating a link to an informational page or pages on the particular property.

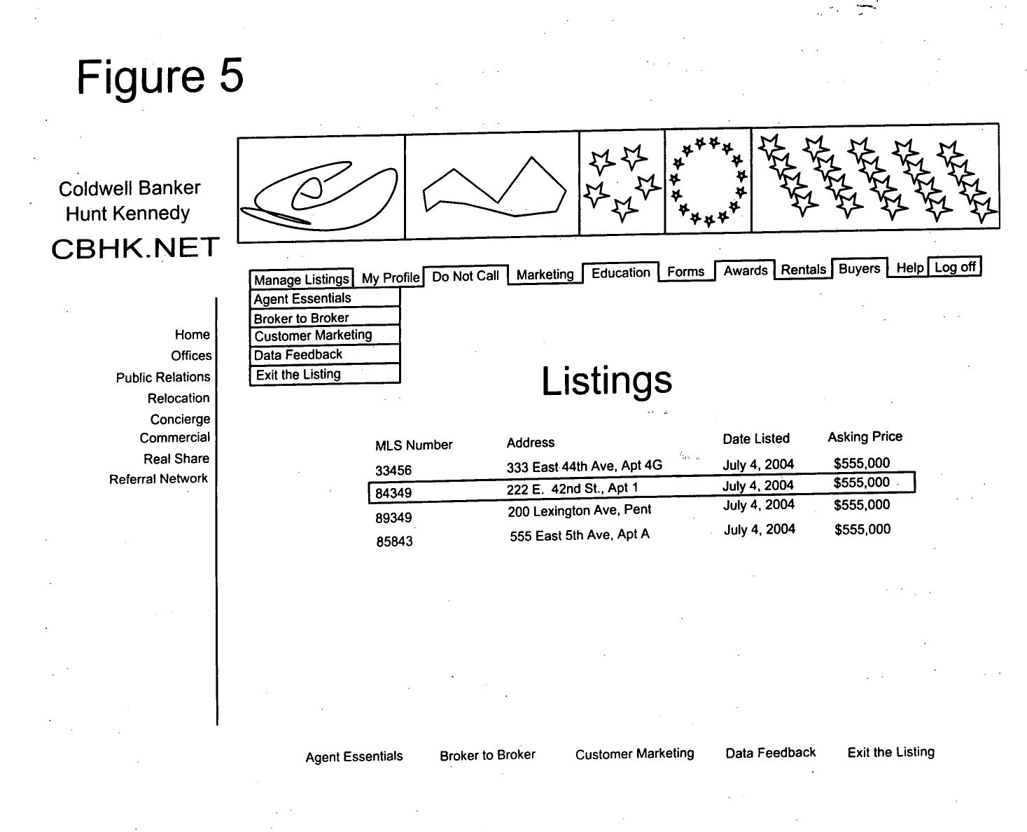

In accordance with the invention, the cursor keys may be used to highlight a particular entry. In the particular example illustrated in FIG. 4, the property associated with MLS number 84349 has been highlighted. By clicking on the line associated with MLS number 84349 in the listings page of FIG. 4, a person visiting the web site, in this case the agent responsible for the listings illustrated in FIG. 4, will be brought to the Agent Essentials page for the particular property, in the event that, as described above, the FIG. 4 page was approached by clicking on the Agent Essentials item in the drop-down menu under Manage Listings. On the other hand, if one of the other drop-down menu listings, Broker to Broker Marketing, Customer Marketing, or Data Feedback (FIG. 5) was selected, with the result of the system bringing the user to the listings page of FIG. 4, clicking on the MLS Number for the listing will result in presentation of the corresponding information for that listing.

Alternately, the web site operator-associated real estate agent user may click on the Manage Listings menu item and select any of the drop-down menu items (Agent Essentials, Broker to Broker Marketing, Customer Marketing, or Data Feedback (FIG. 5)), and get the information on the highlighted listing that corresponds to the drop-down menu item.

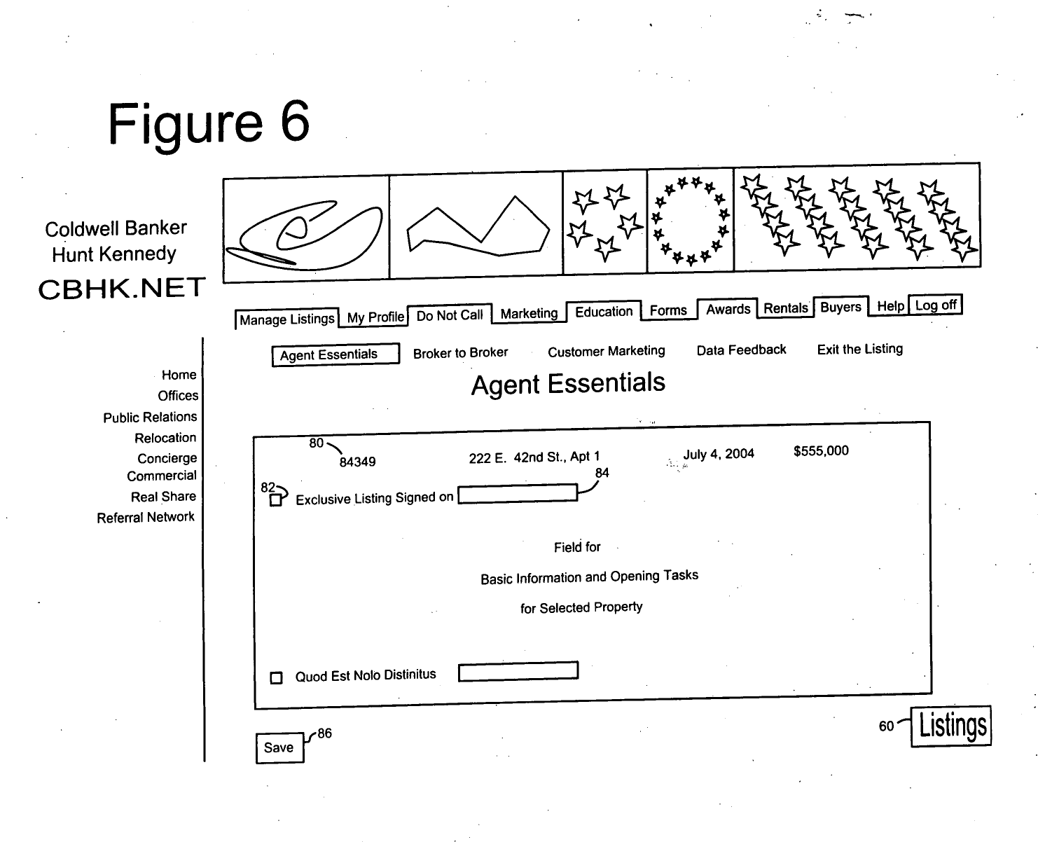

For example, if the Agent Essentials dropdown menu item in the page, illustrated in FIG. 5 is selected, the page illustrated in FIG. 6 will appear. This page generally comprises an identification 80 (such as the MLS number) of the property, followed, underneath, by a list of basic tasks which may need to be completed when a listing is opened.

It is noted that in accordance with the present invention, new properties are entered into the system using the existing MLS system. This information is then automatically gathered by the system of the present invention and initiates entry of a new property into the inventive system.

Accordingly, after the agent has entered the property into the MLS system, it appears in the inventive system. The agent then enters the inventive system, selects the property by clicking listing on the page illustrated in FIG. 3, is brought to the page illustrated in FIG. 4, and selects Manage Listings to call up the display of the drop-down menu as shown in FIG. 5. Clicking on the Agent Essentials submenu item brings out the page illustrated in FIG. 6. The agent then, for example, clicks the box 82 indicating that the exclusive listing has been obtained and then fills in the date in box 84. The balance of the page has similar information in a space reserved for basic information and opening tasks for the selected property, as illustrated in FIG. 6. Such information may take the form of a checklist, including a box that is similar to box 82 for lead paint disclosure signature by seller and agent and the date of the same, the signing of an agency disclosure, the placement of the property on the MLS, if this is not automatic, whether the agent has confirmed the building information provided by MLS through the management company (a dynamic link to a form for filling in changed information may be provided adjacent this entry), an indication of the property as a cooperative or condominium, whether the clients have been registered in the concierge program (as appears more fully below), whether the property has been sent to a co broker list, whether the property has been put on the monthly listing/sales board of the office with which the agent works, whether the agent has obtained a floor plan, given that floor plan to office administrations, and so forth. In addition, the taking of photographs in a real estate agency is standard today.

The page illustrated in FIG. 6 may include, for example, boxes, similar to box 82, each captioned with a property value range and the particular type of photography which is appropriate, and where appropriate a button which may be clicked on to make the appropriate type of photography order and a box to confirm debt arrangements have been made.

For example, the boxes may be captioned “If under $300,000, take digital photographs with hand-held camera”, “If over $300,000 notify office administration to arrange photo shoot (Click here to notify)”, “If over $500,000 order virtual tour from office administration (Click here to order)” and “Photos taken on date: ______”.

Additional information may also be placed on this page, including checklist items for obtaining the offering plan, giving the offering plan to office administration for input into MLS, ordering issue sheet if properties are of appropriate value together with an icon for making such order, requesting an advertisement position in the real estate agency office window, the mailing photos to the client (together with an indication that this is optional), sending floor plans to the client (also indicating the optional nature of this task), ordering of on-site signage where applicable and possible (together with a hyperlink which initiates an e-mail in the form of an order sheet), and confirming the placement of signage on the property together with a space for filling in the date of such placement.

All this information may be saved by clicking on Saved button 86. Button 86 also appears in other screens, as will be described below and functions to save information in those other screens.

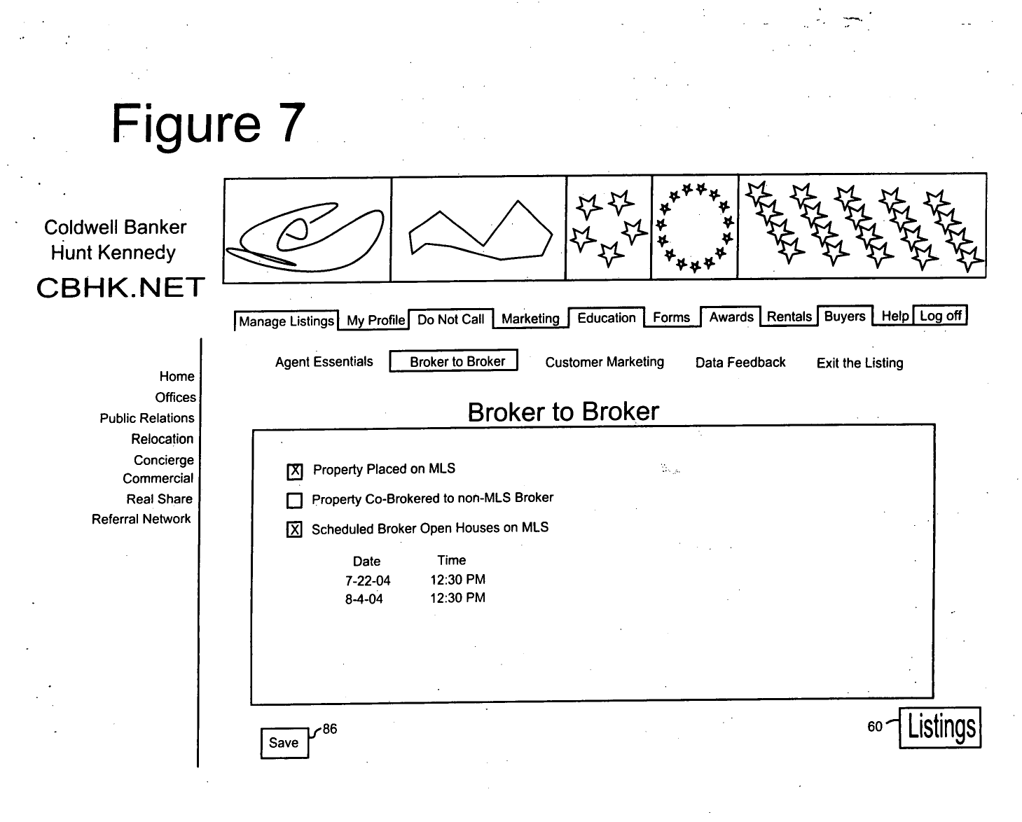

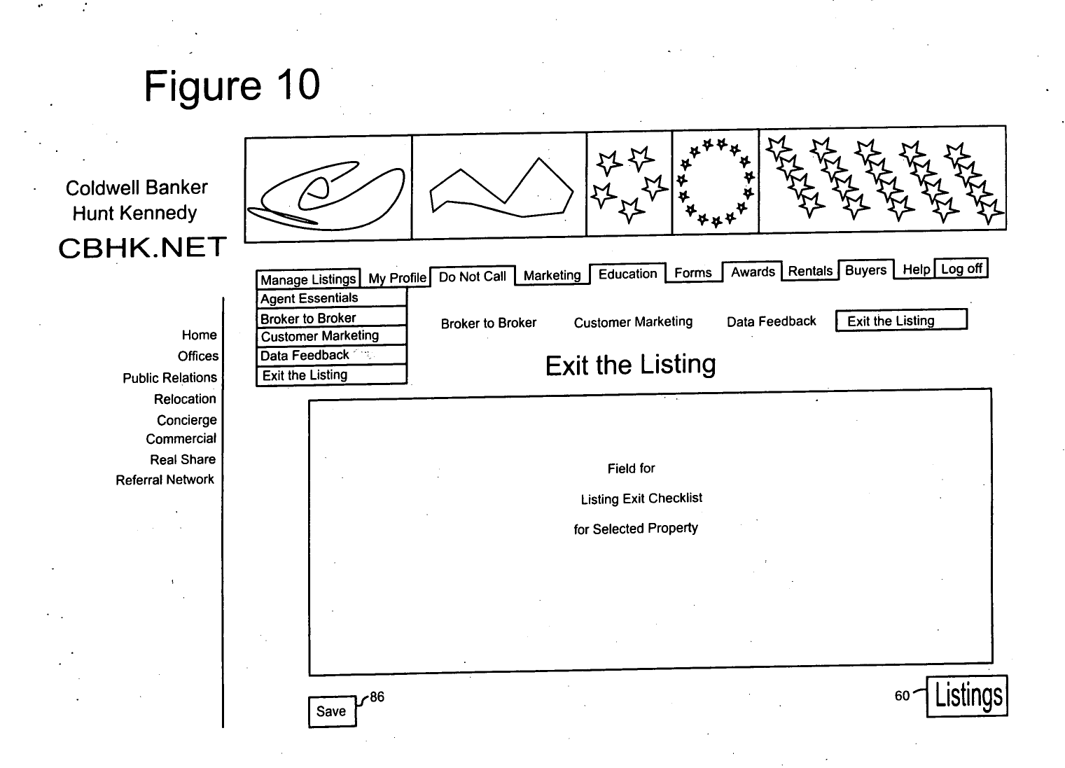

If a user is in one of the pages illustrated in FIGS. 6 through 10, for example, and wishes to have information respecting broker to broker relationships with respect to the subject property, the agent may click on the Manage Listings menu item and then on the Broker to Broker submenu drop-down item. This results in the appearance of the screen illustrated in FIG. 7. This page may include space for placement of the property on the MLS, and the scheduling of open houses, for example, as illustrated in FIG. 7. It is noted that the various pages in the inventive system may include information which appears on one or more other pages. Naturally, when the information is updated on one page, all pages receive the information and are thus updated.

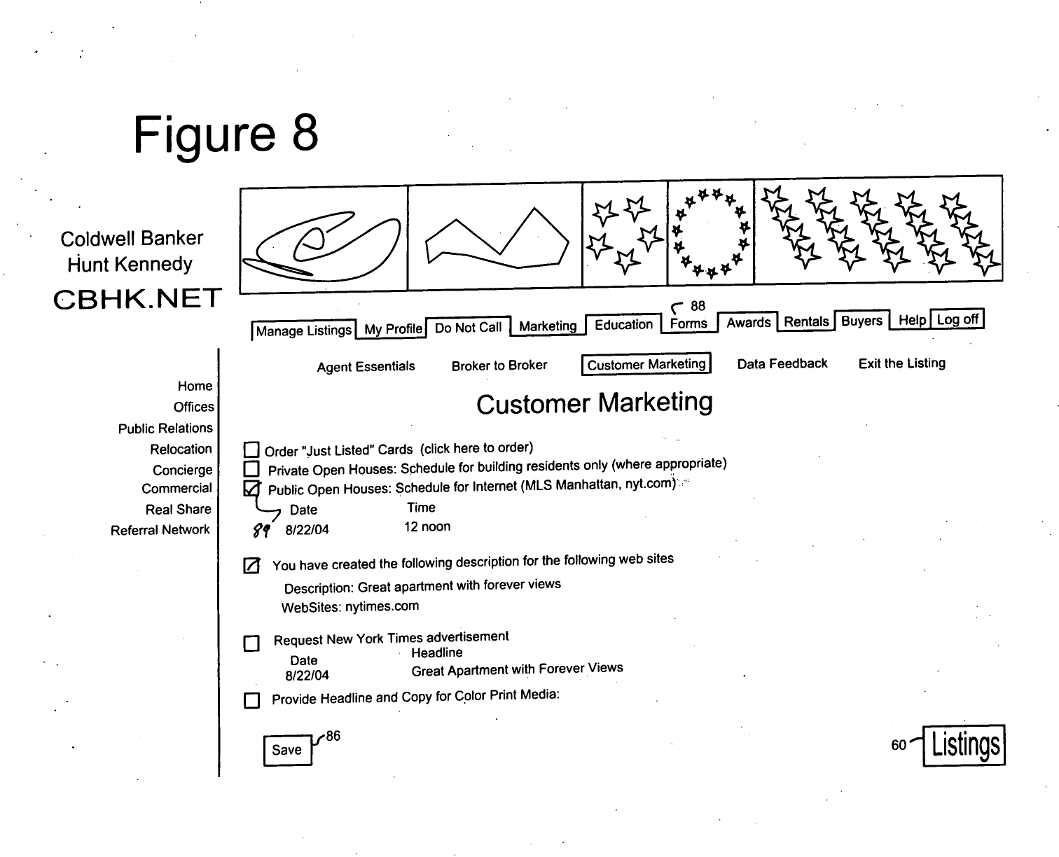

If a user is in one of the pages illustrated in FIGS. 6 through 10, for example, and wishes to have information respecting customer marketing with respect to the subject property, the agent may click on the Manage Listings menu item and then on the Customer Marketing submenu drop-down item. This results in the appearance of the screen illustrated in FIG. 8. This page may include space for customer marketing information and a checklist of tasks which also serves for recording information on the same, as illustrated in FIG. 8.

Similarly to the other pages discussed above, FIG. 8 may function as a checklist, for example prompting the ordering of “just listed” cards, the scheduling of public and private open houses, the writing of a newspaper advertisement, and the scheduling of a newspaper advertisement. In connection with the writing of a newspaper advertisement, the user may click on Forms button 88.

When a task has been completed, a box, such as box 89 may be clicked on causing a check mark to appear in the box.

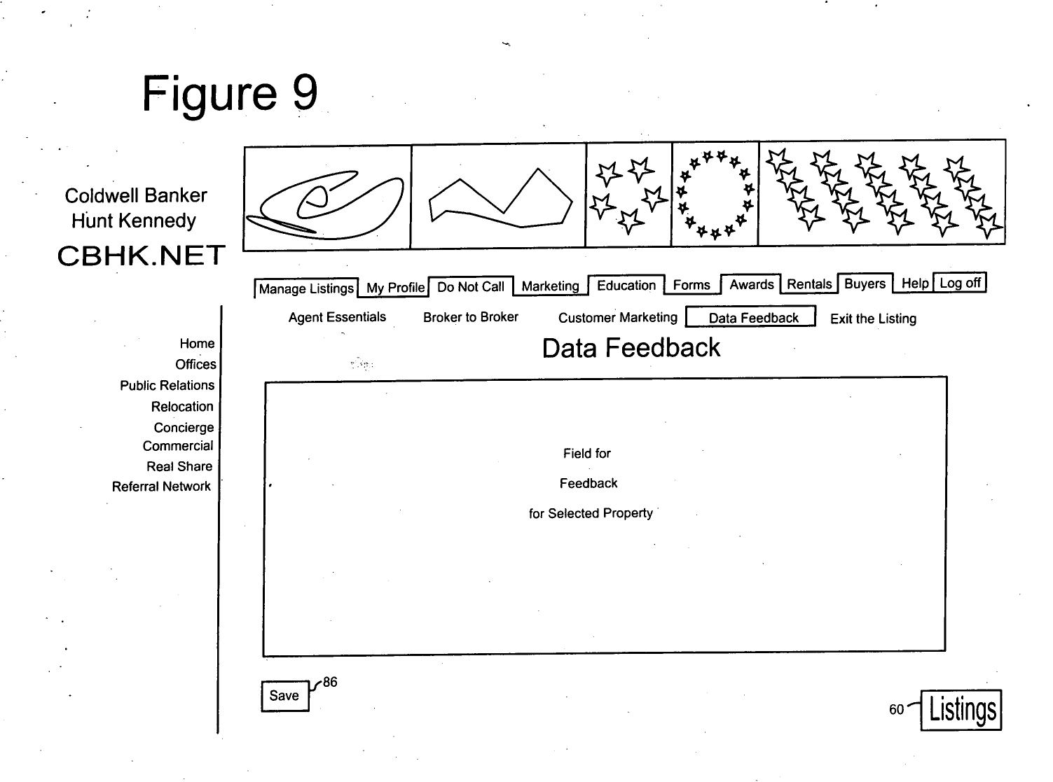

Referring to FIG. 9, information respecting feedback with respect to the listing may be shown in a separate screen. Such feedback may include a listing of the dates on which advertisements ran and the number of responses, a report of responses to a mailing, Internet responses for various websites, including the number of responses and/or the substance of the same.

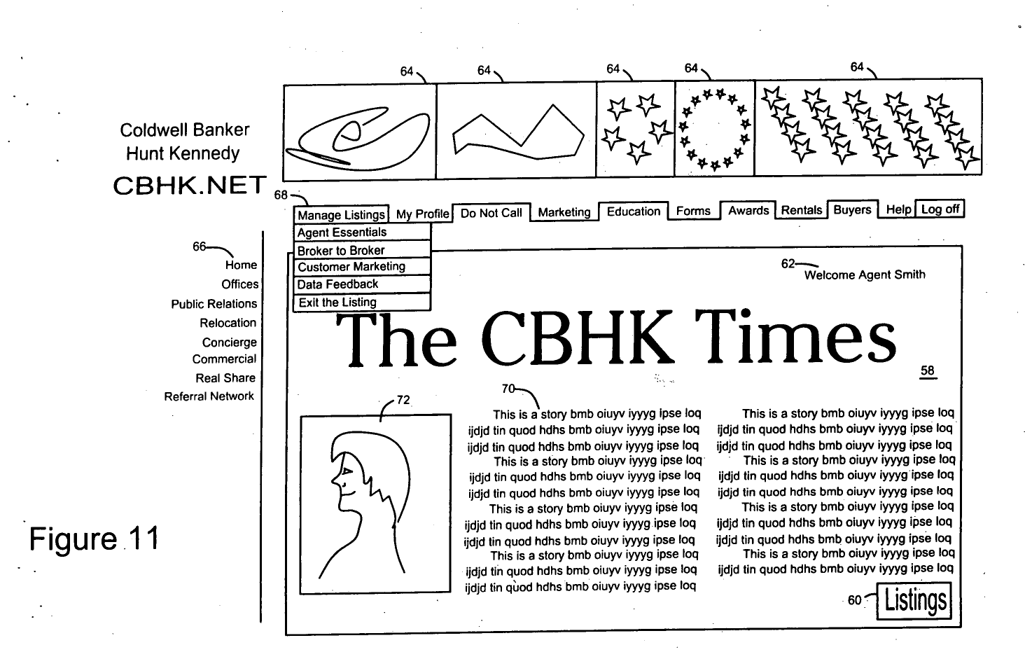

In accordance with the inventive system, when the listing is to be terminated on the system (for example, when an apartment is sold), a number of tasks should be performed. These tasks are listed in a screen that is presented by the system when the Exit the Listing selection is clicked on any of the foregoing screens, or on the Manage Listings submenu. The result is to present the Exit the Listing screen illustrated in FIG. 11.

Typical tasks which may be listed in the Exit the Listing screen as illustrated in FIG. 11 may include the filling out of a transaction fact sheet which should be sent to a co broker, agent and/or attorney. The screen may provide a link to a form which may be printed out or sent by email. The status of the listing may be entered in the appropriate database. If the property is a cooperative apartment, the board application package may be obtained for review with the buyer. The signing of a contract may be noted. The updating of the MLS database may be noted and this done when the contract is signed. The mortgage process may be tracked. Changes in closing dates may be recorded. Execution and tracking of the appraisal process may be done. The checklist should also include a position for noting the sending of a commission bill to the seller's attorney. This page may also include items for closing associated tasks, such as a testimonial, the closing of the item in the MLS database, the request of a “Just Sold” card to be sent to the building, and updating the agent's contacts book.

Referring to FIG. 11, when the real estate agent-user is on the homepage of the web site, the agent may select under Manage Listings any one of five alternatives which will bring a user to the listings page of FIG. 4. If the user then double-clicks on an entry, he will be brought to the page corresponding to the submenu item selected under the Manage Listings menu tab. Alternatively, on the listings page (FIG. 5), either highlighting an entry and then clicking on the appropriate submenu item under Manage Listings, or selecting the appropriate item from the menu on the bottom will bring the user to the corresponding page illustrated in FIGS. 6-10.

The inventive process, after the presentation of the homepage of FIG. 3 at step 56 may be more clearly understood with reference back to FIG. 2. More particularly, at the homepage, the user has several options, including direct selection of listings by clicking on the hyperlink or button 60 at step 90. This results in showing the listings page of FIG. 4, allowing the user to click at step 92 on a selected listing. At step 94 the user selects the type of information wanted by clicking on the type of information in the horizontal menu at the bottom of FIG. 4.

For example, if Agent Essentials is clicked on, the FIG. 6 screen is presented at step 98.

Alternatively, the user may select the information type at step 98 by selecting the information type from a menu of information type presented at the bottom of the screen. This results in producing the listing page of FIG. 4 at step 100. Clicking on a listing at step 102 results in presentation of the immediately previously selected information type for the listing at step 104.

Yet another alternative available to the user is the selection of the information type by clicking on Manage Listings at step 106 and selecting the information type at step 108 from the drop-down submenu. This results in producing the listing page of FIG. 4 at step 110. Clicking on a listing at step 112 results in presentation of the immediately previously selected information at step 108.

After receiving the selected information at step 96, 104 or 112, the user has the option of returning to the listing page to select a different listing, accessing different information from the selection menu at the top of the screen or accessing the different information by selecting manage listings and repeating one of the three above-described alternatives.

Alternatively, the user may choose to edit, fill-in or otherwise work with the information displayed at step 116.

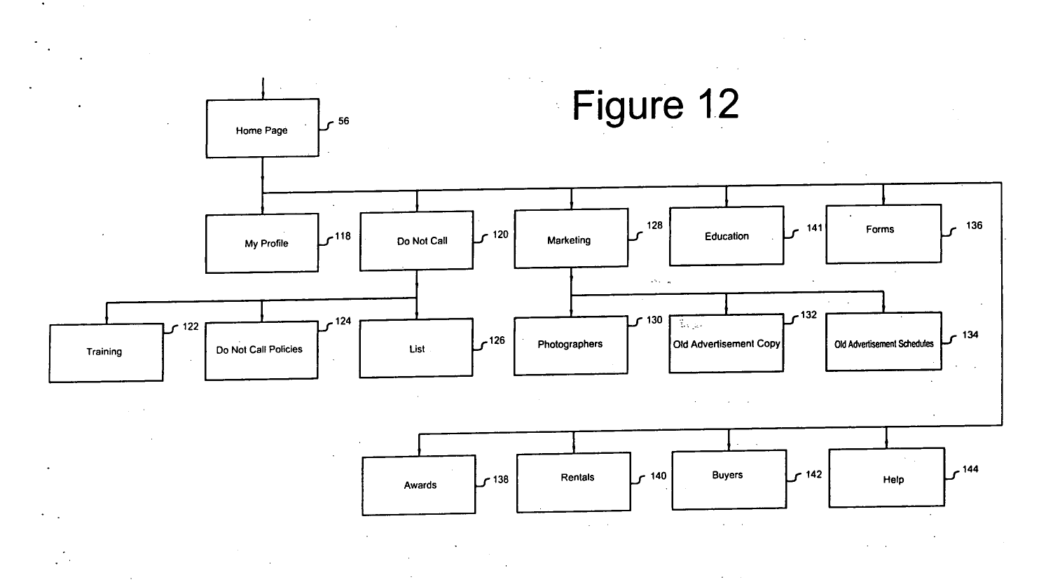

Referring to FIG. 12, the user has other options at the homepage. More particularly, the user may click on the My Profile button at step 118 and cause the system to display a page including blanks which may be filled in, and, augmented and so forth. More particularly, such page may include positions for the recordation of such information as the name of the agent, the office address of the agent, the e-mail address of the agent, the languages that the agent speaks, credentials, marketing specialties, and so forth. This information may, in turn, be made available on the publicly available web site that the agency runs showing its agents, listings and so forth.

At step 120, the user may click on the Do Not Call button. This will cause the display of a number of options and pages whose content is dictated by the Do Not Call law. For example, the user may select training by advancing the system to step 122, or the user may read the “do not call” policies which he may select at step 124, or access the local or a national do not call list at step 126.

Another alternative is for the user to click on the Marketing button at step 128, providing access to databases of various types of information, all of which may be accessed through other portions of the inventive system. For example, at step 130 the system, when prompted by the user, will present a list of photographers who are professionals doing still photography or virtual tour photography, or video. At step 132, the user is given access to old advertisements in order to assist the user in generating new advertisements. At step 134, the user is given access to old advertisement schedules for planning effective advertising. Such advertising schedules may be associated with various properties and show various performance parameters associated with the advertising, such as number of responses, speed in obtaining a sale, the general parameters of a property, and the text of the advertisement, so that judgment may be made to achieve the most effective advertising schedules, content and so forth for the particular type of property being sold. Other information may also be provided in response to the clicking of the Marketing button. For example, a calendar of upcoming print advertisements may be presented. Other suppliers, such as floor plan artist, and the like may also be presented. Information available and even information accessible in other parts of the web site may also be presented in response to clicking of the Marketing button. For example, a buyer's handbook can be presented, a renter's guide can be presented, a rental marketing plan can be presented, including marketing plans with or without preview, as well as copies of agency logos for use in various locations and for various functions. In addition, forms necessary in the course of marketing may also be presented, such as a listing disclosure form, open house sign-in sheets, and so forth. Alternatively, an electronic sign-in sheet, as opposed to one which is to be printed, may be presented on the laptop of the user who is in communication with the system through the Internet at a remote location, perhaps the location of the particular property, for the real-time entry of data into the system as visitors come to visit the system. Such an approach results in a maximization of the information input into the system and the accuracy of the same, thus improving the reliability of databases generated in the course of operating the system for future marketing efforts.

At the homepage the user may also click on the Forms button to have access to various forms used in the real estate business. It is also contemplated that forms specific to the system may also be included, such as a photography order form, commission and listing information forms and so forth all of which may be associated with automatic e-mail being forwarded to an intended recipient or contain a menu of potential recipients to receive the form once it is filled out. Such recipients may be other agents, back-office personnel of the real estate agency, the MLS or multiple listing service, newspapers, potential buyers, and so forth.

The real estate agent user of the system may also click on the Awards button, causing the system at step 138 to present information respecting the requirements and qualifications for various awards and, optionally, presenting information respecting the agents eligibility, performance, and other related factors with respect to the agent's own progress respecting the earning of awards. The clicking on the Awards button may also provide options for the agent to see current award winners, as well as past award winners of various types.

The agent also has the option, in accordance with the invention, of clicking on the Rentals button and being presented at step 140 with information respecting rentals, including a renter's guides, a credit report authorization form, a credit transaction report request form, rental lease application forms, a rental marketing plan to present to property owners, listing agreements with property owners, and sample leases.

The inventive system also includes an Education button or link on its homepage. Clicking on the Education button causes the system to advance at step 141 to provide a number of options to the user which when clicked on provide information to the user. Such options are a calendar of educational events, information about upcoming previews, information about previews and their function, information about listings and their function, information for new agents, and other educational offerings.

At step 142, buyers information is presented in response to the clicking of the Buyers button on the homepage. Such buyer information may include buyer names, telephone numbers and addresses, as well as information on the type of property being sought by a buyer. In accordance with the invention, it is provided that such information may be searched to find appropriate buyers for a particular property. Such searching mechanisms may be of a conventional nature.

At step 144, in response to the clicking of the Help button at the homepage, e-mail options and access to the voice mail of management personnel at the agency is provided in order to enable the agent to obtain help with a problem.

In accordance with the invention, it is noted that the inventive web site, described in the foregoing portions of the application, cooperates with a publicly available web site which prospective real estate purchasers may visit. This publicly available web site sees information on listings which are generated by the real estate agents working with the agency which operates the inventive internal web site, such as that, for example, illustrated in the homepage of FIG. 3. The publicly available web site includes such information as property, address, price, description, taxes, and photographic information in the form of still-shots, a virtual tour, video and/or other options and a number of which may be employed in connection with a particular property.

In addition to the public and private aspects of the inventive system, there is an additional back-office system, as will be described below, in which the management of the real estate agent may monitor guide and direct the execution of tasks implemented by individual agents.

In addition to these three functions, the inventive system has the feature of integrating with existing MLS databases, allowing access to the listings to other MLS members.

An additional optional aspect of the invention is its ability to incorporate database information respecting properties which is maintained by database operators who specialize in the gathering and maintenance of building information, tax information, and the like. Such database operators usually limit their operations to a particular city, and a large city may have as many as a half dozen or more such database operators.

In accordance with the invention, it is contemplated that the various tasks associated with the foregoing “front office” portion of the system illustrated, for example, in FIGS. 1-12 may be associated with a docketing system associating task completion and reminder dates to assure timely handling of agent responsibilities.

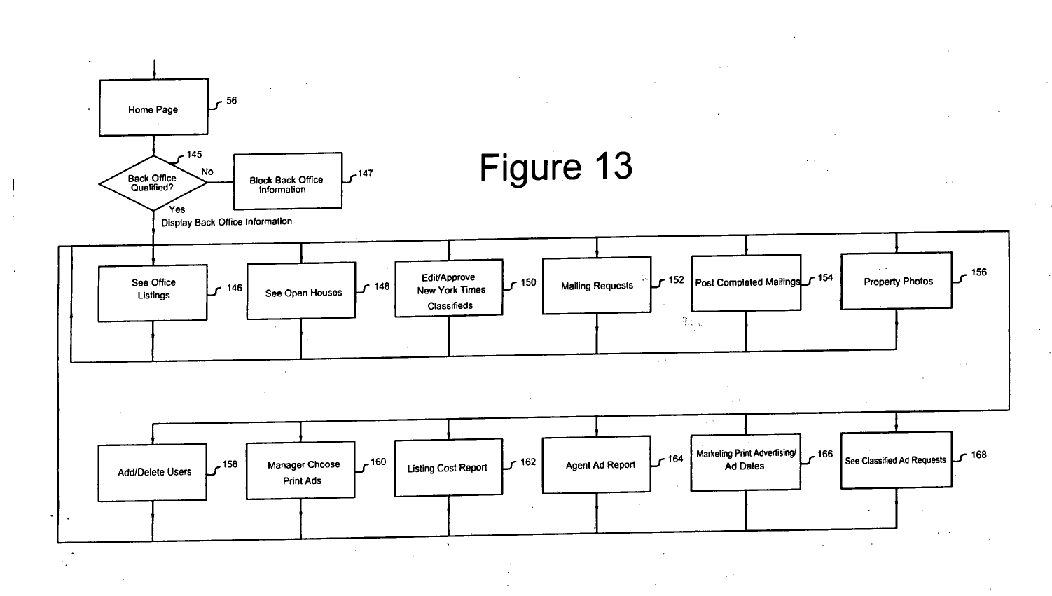

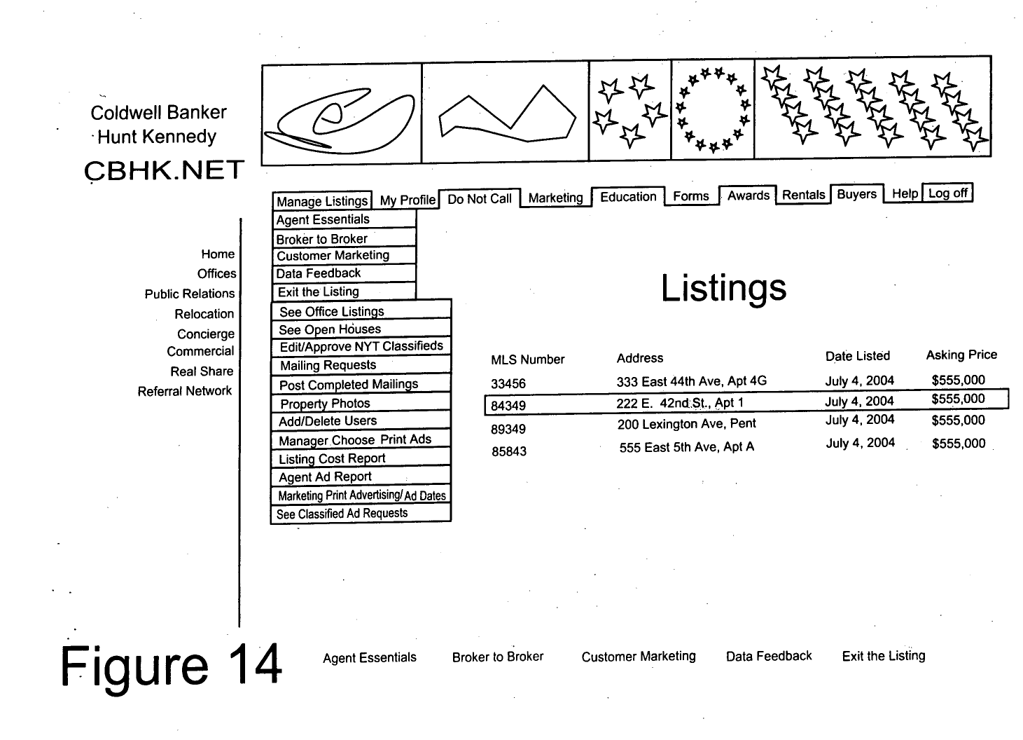

The “back office” portion of the inventive system may be understood with reference to FIG. 13. If, at the homepage the person using the system (who may be an agent-user with higher privileges or a manager) has entered a username and password consistent with one of the back-office personnel, additional system options are presented on the homepage by the system at step 145. Such options take the form of additional menu options under the Manage Listings button, as illustrated in FIG. 14. If the operation of the system by an authorized back office individual is not detected by the system at step 145, the system blocks access to back office menu options and information at step 147.

Back-office operation allows the user at step 146 to click on the Office Listings button to see all listings in the office. Similarly, by clicking on the See Open Houses button at step 148, the user may see all open houses on the system. Similarly, management personnel may, at step 150, click on any button which presents information which allows them to edit and approve New York Times or other newspaper classifieds.

In accordance with the invention, it is contemplated that the ordering of newspaper advertisement and newspaper copy will be done by email. Real estate agent users compose and finalize e-mails, but they may not immediately be sent. Depending on subject matter and the agent wishing to send the e-mail, the e-mails are accumulated in the system for review edit before forwarding to the relevant publications. Likewise, in accordance with the invention, or other request information, such as a mailing request may be presented by the system at step 152 for management by agency personnel.

At step 156, the system, in response to the clicking on the Property Photos button presents photos of all apartments on the system for review by management personnel.

At step 158, in response to the clicking of the Add/Delete Users button, access to the system by real estate agent users may be limited or enlarged. At step 160, the system presents to a manager various print advertisements for approval. Likewise, costs may be monitored by the manager clicking the Listing Cost Report button, at step 162.

Likewise, an agent authorized cost report may be generated by clicking on the appropriate button at step 164 to monitor the cost-incurring performance of an agent. Advertisement costs may also be monitored by clicking on the appropriate button at step 166. In addition, classified advertisement requests are presented by the system at step 168, in response to back office management personnel clicking on the corresponding button at the homepage, allowing for approval by management which simply clicks to obtain the information and a place to control the activity.

It is noted that various modifications to the system of the present invention may be made without departing from the spirit and scope of the invention which is limited and defined only by the appended claims. For example, features may be added to the inventive system, features may be modified and features may be deleted from those discussed above.

In accordance with the invention, when user-agents click on the Home button 180 in any of the aforementioned screens, the system brings the user back to the homepage of the agent-accessable website illustrated in FIG. 3. The homepage includes the menu of a number of informational selections 66.

The inventive system also provides for looking up information relating to the various offices operated by the operator of the agent-accessible web site whose homepage is illustrated in FIG. 3. This is implemented when the cursor is put over the button associated with the Offices button 182, causing a submenu including Telephone Directories and Deal Tracking options to pop up. When the user-agent clicks on Telephone Directories the website displays telephone numbers of various offices, other employees, and/or other information related to the real estate office that might be helpful to the user-agent. In addition, when the user-agent clicks on Deal Tracking, he is able to view the history of actions and results that have occurred with each property, allowing analysis of the same.

The inventive system also includes a Public Relations feature, which is called up by clicking on button 184. In the real estate business, it is important to know what kind of communication the real estate business has in respect to the community, as well as the knowledge-base that the real estate agency shares with its potential customer constituency. When the user agent moves his cursor over the Public Relations button a submenu which contains a list of Press Releases and News Clippings opens. The user-agent can click on Press Releases which shows the latest announcements that the real estate agency, which is operating the website, has made publicly, in regards to events, programs, and or achievements. A News Clippings submenu item button, under the Public Relations button, when clicked on, displays various news articles cut from newspapers and/or magazines. These articles can be viewed by links referring to other informative websites and/or can be viewed by articles scanned to a desired file type format, such as PDF, JPG, etc.

In accordance with the inventive system, it contemplated that user-agents will have to work with clients that might need to be relocated. The Relocation button 186 is provided to access useful information for such and related purposes. User-agents may look up a variety of services that the real estate agency operating the inventive web site offers to their potential buyers, in the process of relocating to a new location. When the user-agent moves the cursor over Relocation, a submenu pops up listing, for example: Important Contact Numbers, What RELO Does, Cendant Requirements, City Realty Requirements, Recent Events and Updates, Local News, First Contact List, Corporate Lead Program, A-Team Requirements, A-Team Members, RELO Forms, RELO Terms, and Top Conversion Ratios. The user-agent can then select any of the sections in the list, by clicking on the button.

Telephone numbers of persons that specialize and/or perform relocating services may be found in the Important Contact Numbers section. By clicking on the What RELO Does, the user-agent is given an explanation what the relocating service of the web site operating agency does for the client (This may be a link to the same information that the client views in the public site). Cendant Requirements and City Realty Requirements provide links to other real estate websites that also provide listings. This enables the real estate agent user to access properties listed by other agencies where properties of the inventive web site operator may not fulfill a particular customer's needs. Updates, such as changes to requirements of RELO, and/or any information on events, such as seminars or courses needed for this service are provided by clicking on Recent Events and Updates. By clicking on Local News the user-agent, by providing a zip code for example, can view the local news of the area specified, in order to better serve the client. In the First Contact List, the user-agent can contact the primary person of the client's household or business. Corporate Lead Program is an information database which enables the corporation and the real estate agency to work together in order to find the client/buyer the right location. A-Team Requirements and A-Team Members provide database access to special programs and primary context for implementing such programs. The user-agent can find the proper forms for the relocating program by clicking on the RELO Forms button. The user-agent can look up various relocating terms the might be useful to accommodate the buyer. (This may be a link to the same information that the client views in the late publically accessible web site). Finally, in viewing the results of the RELO program, the Top Conversion Ratios button may be clicked on to view highest performing elements on the system.

The French term for a doorman is Concierge. The operator of the inventive web site may wish to provide its buyers with help them get started in buying or selling their home. By moving the cursor over a Concierge button 188, a submenu pops up listing: Forms, Ads, Marketing Info, Articles About, Furniture Rental Companies, which all these buttons can be clicked on by the user-agent to access information about local services for helping the buyer/client buy, sell or owning a home.

The user-agent can click on Forms in order to download and/or print documents to subscribe the buyer to the concierge program in accordance with which the potential buyer is provided with useful information. Related advertisements that are posted on websites and/or in magazines about the Concierge program may be found by clicking on the Ads button. The Marketing Info button can be clicked on by the user-agent to access information about the process of planning and executing the activities in pricing, promoting, and advertising the Concierge service. Various articles about the Concierge program, either written by real estate magazines, public newspapers, and/or other user-agents, can be found by clicking on the Articles About button. In addition to helping clients with local services on buying and selling homes, using the Concierge program, a Furniture Rental Companies button is provided for clients that are temporarily looking to rent furniture instead of purchasing by providing a list of such companies. This may be a link to the same information that the client views in the public site.

In accordance with the present invention, the real estate agency which is operating the inventive web site may offer real estate in the residential sector of the market and in the commercial sector. By moving the cursor over Commercial button 190, the user-agent will deal with only commercial listings. A submenu will pop up which will contain a menu of Listing Forms, Telephone Directory, Co-Brokerage Agreements, and Commission Agreements. User-agents will be able to view, print, and/or download the applicable forms for listing commercial property by clicking on the Listing Forms button in the submenu. A list of useful commercial real estate related phone numbers can be found by clicking on the Telephone Directory.

In accordance with the invention, the operator of the inventive web site may have developed co-brokerage agreements between listing brokers and selling brokers in regards to selling commercial properties. User-agents can find the applicable forms by clicking on the Co-Brokerage Agreement button. By clicking on the Commission Agreements button, the user-agent will be able to download, print, and/or view the applicable forms.

Further in accordance with the present invention, the website also has an option where the user-agents can move the cursor over Real Share button 192 which will pop up a submenu which includes the following items: Vision and Mission Statements, Telephone Directory, Events Calendar, Organization Chart, Policies and Procedures, Employee Benefits Handbook, Link to Oxford, Time off Request, and Annual Report. These items are provided for user-agents that are interested in working with the agency, either as agents, or in connection with a specific property. Here real estate agent users can find information about being partners and view benefits that the company offers. The Vision and Mission Statement button can be clicked on to view the goals of the real estate company. The submenu also has a Telephone Directory button that can be clicked on to view contacts for the Real Share program. The Events Calendar button can be clicked on to see proposed events, banquets, and/or seminars on the Real Share program. Charts of the structure of the Real Share program staffing and/or functions can be viewed by clicking on the Organization Chart button. The Real Share program has bylaws, procedures and policies that the employees and partners must follow, which can be viewed by clicking on the Policies and Procedures button. The user-agents can view their handbook by clicking on the Employee Benefits Handbook button. Many companies offer healthcare benefits to their employees and partners, including medical insurance benefits. For example, the user-agent can view a program with Oxford health insurance by clicking on a Link to Oxford. User-agents that are in the Real Share program can request time off from work by clicking on the Time off Request button. Annual reports of the company's profit/employee's sales records for the year can be viewed by user-agents by clicking on the Annual Report button.

In accordance with the inventive system, the inventive web site operator also has a subsidiary company called Referral Network. This company is designed as a separate brokerage company for user-agents that don't want to participate in sale or listing of real estate property. By clicking the cursor over Referral Network button 194, user agents are able to find Forms, Ads, Marketing Info, Articles About, and Furniture Rental Companies all in a submenu. The Forms button may be clicked to print, view, and/or download the forms needed for the Referral Network company. Furthermore, user-agents can view different advertisements that the real estate company; for example, Coldwell Banker, displays to the public by clicking on the Ads button. The Marketing Info button can be clicked on by the user-agent to access information about the process of planning and executing the activities in pricing, promoting, and advertising the Referral Network service. Various articles about the Referral Network program, either written by real estate magazines, public newspapers, and/or other user-agents, can be found by clicking on the Articles About button. In addition to helping clients with local services on buying and selling homes, using the Referral Network program, a Furniture Rental Companies button may employed and is useful for clients that are temporarily looking to rent furniture instead of purchasing. This may be a link to the same information that the client views in the public site.

A system 200 for implementing the method of the present invention is illustrated in FIG. 15. In accordance with this embodiment of the invention, communications between and among people, organizations and the system, as well as other web sites and services is made over the Internet 202. Real estate user-agents 206, located, for example, in their homes, communicate with the system through the Internet. In similar fashion, potential clients 206 also communicate with the system and other persons associated with the system using the Internet.

In similar fashion, information prompted publicly available web sites 208 are made available to the system using the Internet. Computer 210, on which the inventive web sites, including publicly accessible web site 212 and the web site accessible only to real estate agent-users and management personnel, 214 is connected to existing multiple listing service (MLS) electronic network 216.

A manager 218 may be connected, by the Internet, to the central computer 210 operating the system, or he may be located on premises as illustrated in FIG. 15. In accordance with the invention, a manager 218 is performing numerous functions including receiving reports and documents for approval, as well as transmitting approvals, for such things as the sending of an order to a clipping service 220, inspecting a particular property or the agency operating the inventive system. In similar fashion, approvals may be sent to a photographer 222, a newspaper 224, which is to run an advertisement for a particular property listed by the real estate agency, or to a printer 226 who is producing, for example cards, to be mailed as announcing the sale of the property.

In accordance with the invention system 200 is automatically connected to the existing local property information database 228, as is described above.

The inventive system may be better understood with reference to FIG. 16. In particular, at step 252, the system is entered and action taken by an agent-user, such as initiation of the listing or the updating or amendment of the listing. The initiation of the listing at step 252 causes the implementation of docket deadlines at step 254. The implementation of docket deadlines at step 254 prompts periodic docket checks at step 256 and the prompting of action by an agent-user, for example, at step 258.

In response to a user requests, checklists including fields for entry of data are presented at step 260. If a form is required, which is determined at step 262, a form is transmitted at step 264, prompting action by the agent at step 266. If a form is not required, agent action is received at step 266. Such action may be the ordering of an advertisement, the wording of an advertisement, ordering of cards, or the like. Such action is not directly executed in accordance with the invention, but is transmitted for approval to a manager at step 268. Such transmission may be by e-mail, or the agent's action may be sent to a database for periodic call up and review by management personnel, as described above.

If a manager does not approve, at step 270, the action is amended at step 272. If a manager does approve at step 270, the action causes the storage of actual costs incurred by the agent at step 274 and the storage of the costs associated with the property at step 276. In addition, the action is executed at step 278, for example by the sending of an e-mail to the supplier, newspaper or the like.

At step 260, the system also presents the agent with the opportunity to enter information about himself in step 280. This is storage and an agent information database at step 282, as detailed above. Other information respecting the agent, as will be described above, is also stored in the system, resulting in the opportunity to generate periodic reports on agent performance at step 284. Such reports are sent to a manager at step 286, either by e-mail or by storing the same for call up by the manager at a time convenient to the manager. Review of the reports by the manager is done by computer with opportunities for the manager to amend action.

If a problem has been detected and it is not possible to amend the action, the manager has the opportunity to send e-mail guidance at step 290 to individuals or groups to prevent future problems of the sort detected. If it is possible to amend the action, for example to change the text of an advertisement in a newspaper before the deadline for that advertisement has expired, the option is presented onscreen to the manager if such option has been detected at step 288. If the manager clicks on the presented but at step 288 and elects to take corrective action, such action is executed at step 292, for example by the sending of an e-mail at step 278.

In connection with agent reports, it is noted that agent actions and their cost consequences are stored at step 294 and that this information is also fed into the reports generated at step 284 to show the difference in cost between actual agent requests and corrected agent actions.

While an illustrative embodiment of the invention has been described, it is, of course, understood that various modifications will be apparent to those of ordinary skill in the art. Such modifications are within the spirit and scope of the invention which is limited and defined only by the appended claims.

1. A method of implementing and controlling a real estate transaction, comprising:
(a) receiving an agent identification from a particular agent;
(b) receiving a request from said agent to implement the real estate transaction with respect to a particular property;
(c) presenting a screen or a plurality of screens to said agent comprising:
(i) a listing of a plurality of tasks to be done in connection with the real estate transaction;
(ii) a plurality of fields for receiving information; and
(iii) a plurality of icons linking to request forms to be filled; and
(d) generating a requested item cost associated with said task, if any, and storing said cost as cost information associated with a property and/or agent.

2. A method as in claim 1, further comprising:
(e) receiving information respecting the type of the property and the value of the property;
(f) generating average cost figures associated with properties of different type and value, and costs incurred by said particular agent; and
(g) generating a report indicating the cost associated with said particular property or said particular agent compared to said average cost figures.

3. A method of implementing and controlling a real estate transaction, comprising:
(a) receiving a request to implement a real estate transaction;
(b) presenting a screen comprising:
(i) a listing of a plurality of tasks to be done;
(ii) a plurality of fields for receiving information indicating the details of a particular property associated with said real estate transaction; and
(iii) a plurality of icons linking to request forms to be filled;
(c) storing a filled-in request form;
(d) forwarding said filled-in request form to a manager for approval or amendment;
(e) receiving an approval or amendment from a manager; and
(f) forwarding said filled-in request form and any amendment to a supplier in response to the receipt of said approval.

4. A method as in claim 3, wherein said receiving a request is implemented over the Internet.

5. A method as in claim 3, wherein said forwarding is done over the Internet.

6. A method as in claim 3, further comprising:
(g) setting deadline dates for agent and manager in response to said receiving a request;
(h) receiving agent task performance and manager approval performance information into a task and approval performance database;
(i) periodically checking said task and approval performance database updated in response to management and agent actions to ascertain whether a deadline item has been executed, or an approval or amendment given; and
(j) sending a reminder to a manager for those unperformed tasks for which a manager is responsible with respect to an unexecuted item and/or to an agent for an unexecuted task for which the agent is responsible.

7. A method as in claim 3, further comprising:
(k) implementing a public website configured to incorporate said details; and
(l) receiving personal details on an agent for inclusion in said public website.

8. A method as in claim 3, wherein one of said plurality of tasks is placing an advertisement in a store front window, and an icon associated with a representation of said task may be clicked upon to implement a request for a replacement of an advertisement in front of a storefront window.

9. A method of implementing and controlling a real estate transaction, comprising:
(a) receiving a request from an agent to implement a real estate transaction with respect to a particular property;
(b) presenting a screen comprising:
(i) a listing of a plurality of tasks to be done;
(ii) a plurality of fields for receiving information; and
(iii) a plurality of icons linking to request forms to be filled; and
(c) presenting a form to be filled in by said agent; and
(d) receiving from said agent information comprising an advertisement, a scheduling of an open house or an order for a photo shoot or virtual tour of a listed property.

10. A method as in claim 9, wherein the advertisement, scheduling of an open house, or photo shoot or virtual tour of said listed property may go to a manager for approval before it is transmitted.

11. A method of implementing and controlling a real estate transaction, comprising:
(a) implementing a web site or used only an agent broker;
(b) receiving a request from an agent to implement a real estate transaction with respect to a particular property;
(c) presenting a screen, comprising:
(i) a listing of a plurality of tasks to be done;
(ii) a plurality of fields for receiving information; and
(iii) a plurality of icons linking to request forms to be filled-in; and
(d) presenting hyperlinks to a plurality programs for agent-users.

12. A method as in claim 11, wherein one of said plurality of programs comprises an agent education program, wherein said agent can use online educational facilities and may take online courses related to a specific field of real estate.

13. A method as in claim 11, wherein one of said plurality of programs, is selected from the group consisting of:
(a) an agent profile program where the agent may enter personal information detailing their experience in the real estate field, such as education level, prior work experience, and/or their performance level;
(b) agent education program presenting said agent with an online course in a specific field of the real estate trade;
(c) an incentives program for databasing cumulative points earned by the agents, the number of cumulative points being function factors selected from the group consisting of:
(i) agent performance;
(ii) associated points;
(iii) algorithmic assessments of the same;
(iv) coworker and customer feedback;
(v) educational courses completed; and
(vi) manager ratings;
(d) a concierge program for presenting said agent information respecting resources to help buyers and sellers of real estate to maintain and move into said particular property; and
(e) a relocation program for presenting to said agent relocation information.

14. A method as in claim 13, further comprising:
(f) receiving information respecting the type of the property and the value of the property;
(g) generating average cost figures associated with properties of different type and value, and costs incurred by said particular agent; and
(h) generating a report indicating the cost associated with said particular property or said particular agent compared to said average cost figures.
